(19) United States
(12) Patent Application Publication
(10) Pub. No.: US 2025/0193915 A1
(43) Pub. Date: Jun. 12, 2025

(54) A METHOD, SYSTEM, AND WIRELESS NODE FOR REDUCING INTERFERENCE

(71) Applicant: Sony Group Corporation, Tokyo (JP)

(72) Inventors: Erik BENGTSSON, Eslöv (SE); Jose FLORDELIS, Lund (SE); Fredrik RUSEK, Eslöv (SE); Olof ZANDER, Södra Sandby (SE); Kun ZHAO, Malmö (SE); Chaitanya TUMULA, Åkarp (SE)

(21) Appl. No.: 18/844,965

(22) PCT Filed: Mar. 17, 2023
(86) PCT No.: PCT/EP2023/056903

§ 371 Date: Sep. 8, 2024

(30) Foreign Application Priority Data
Mar. 28, 2022 (SE) 2250376-7

(51) Int. Cl. H04W 72/541; H04W 16/26

(52) U.S. Cl. CPC H04W 72/541; H04W 16/26

(57) ABSTRACT

A method, performed by an interference monitoring node is disclosed. The method includes obtaining, from at least one network node, an interference parameter associated with at least one coverage enhancing device capable of transmitting a signal in a cell of the at least one network node, wherein the interference parameter is indicative of a time stamp of transmission of the signal, and an interference level during transmission of the signal. The method includes determining, based on the interference parameter, a configuration parameter indicative of a change in resource allocation of the cell and/or a change in coverage enhancing device configuration for reducing the interference level of an upcoming signal. The method includes providing instructions for the at least one network node to apply the configuration parameter to the upcoming signal transmissions of the at least one coverage enhancing device.

The present disclosure pertains to the field of wireless communications. The present disclosure relates to a method for reducing interference with coverage enhancing devices, and a related device.

### BACKGROUND

In a wireless communication system, interference can be a problem when sending and/or receiving signals, both within a cell and between different cells. This can further be complicated by the use of coverage enhancing devices, which can increase the overall interference in a system depending on how they are configured.

### SUMMARY

Accordingly, there is a need for network nodes, systems, and methods that can reduce interference within a wireless communication system, which may mitigate, alleviate or address the shortcomings existing and may provide for an overall determination and reduction of interference within a coverage enhancing device enhanced wireless communication system.

A method is disclosed. The method is performed by an interference monitoring node. The method includes obtaining, from at least one network node, an interference parameter associated with at least one coverage enhancing device capable of transmitting a signal in a cell of the at least one network node. The interference parameter is indicative of a time stamp of transmission of the signal. The interference parameter is indicative of an interference level during transmission of the signal. The method includes determining, based on the interference parameter, a configuration parameter indicative of a change in resource allocation of the cell and/or a change in coverage enhancing device configuration for reducing the interference level of an upcoming signal. The method includes optionally providing instructions for the at least one network node to apply the configuration parameter to the upcoming signal transmissions of the at least one coverage enhancing device.

It is an advantage of the present disclosure that interference parameters indicative of interference levels caused by coverage enhancing devices (CEDs) can be obtained, and interference causation can be determined. This can allow for assessment and changes within a wireless system to reduce and/or eliminate interference which may be caused by the CEDs. A plurality of different interference parameters can be obtained from a plurality of different network nodes, thus allowing for comprehensive analysis and adjustment of a wireless system for an overall interference reduction. Moreover, a certain degree of interference avoidance can be done based on historical patterns, instead of measuring the current interference situation using reference symbols, which can lead to less overhead.

Further, a system for reducing signal interference is provided. The system includes at least one network node. The system includes at least one coverage enhancing device within a cell of the at least one network node. The system includes an interference monitoring node in communication with the at least one network node. The interference monitoring node is configured to obtain, from the at least one network node, an interference parameter associated with the at least one coverage enhancing device capable of transmitting a signal in a cell of the at least one network node. The interference parameter is indicative of a time stamp of transmission of the signal. The interference parameter is indicative of an interference level during transmission of the signal. The interference monitoring node is configured to determine, based on the interference parameter, a configuration parameter indicative of a change in resource allocation of the cell and/or a change in coverage enhancing device configuration for reducing the interference level of an upcoming signal. The interference monitoring node is optionally configured to provide instructions for the at least one network node to apply the configuration parameter to the upcoming signal transmissions of the at least one coverage enhancing device.

It is an advantage of the present disclosure that interference parameters indicative of interference levels caused by CEDs can be obtained, and interference causation can be determined. This can allow for assessment and changes within a wireless system to reduce and/or eliminate interference which may be caused by the CEDs. A plurality of different interference parameters can be obtained from a plurality of different network nodes, thus allowing for comprehensive analysis and adjustment of a wireless system for an overall interference reduction. Moreover, a certain degree of interference avoidance can be done based on historical patterns, instead of measuring the current interference situation using reference symbols, which can lead to less overhead.

Further, a network node configured to reduce signal interference is provided. The network node includes memory circuitry. The network node includes a wireless interface. The network node includes processor circuitry. The processor circuitry is configured to provide, to an interference monitoring node, an interference parameter associated with the at least one coverage enhancing device capable of transmitting a signal in a cell of the network node. The interference parameter is indicative of a time stamp of transmission of the signal. The interference parameter is indicative of an interference level during transmission of the signal. The processor circuitry is configured to receive, based on the interference parameter, a configuration parameter indicative of a change in resource allocation of the cell and/or a change in coverage enhancing device configuration for reducing the interference level of an upcoming signal. The processor circuitry is optionally configured to apply the configuration parameter to the upcoming signal transmissions of the at least one coverage enhancing device.

It is an advantage of the present disclosure that interference parameters indicative of interference levels caused by CEDs can be provided by the network node, either to the network node itself (so within the network node) or to a different interference monitoring node, and interference causation can be determined. This can allow for assessment for the network node to make changes to reduce and/or eliminate interference which may be caused by the CEDs. Moreover, a certain degree of interference avoidance can be done based on historical patterns, instead of measuring the current interference situation using reference symbols, which can lead to less overhead.

Further, an interference monitoring node configured to reduce signal interference is provided. The interference monitoring node comprises memory circuitry. The interference monitoring node comprises a wireless interface. The interference monitoring node comprises processor circuitry. The processor circuitry is configured to obtain an interference parameter associated with the at least one coverage enhancing device capable of transmitting a signal in a cell of at least one network node. The interference parameter is indicative of a time stamp of transmission of the signal. The interference parameter is indicative of an interference level during transmission of the signal. The processor circuitry is configured to determine, based on the interference parameter, a configuration parameter indicative of a change in resource allocation of the cell and/or a change in coverage enhancing device configuration for reducing the interference level of an upcoming signal. The processor circuitry is configured to provide instructions for the at least one network node to apply the configuration parameter to the upcoming signal transmissions of the at least one coverage enhancing device.

It is an advantage of the present disclosure that interference parameters indicative of interference levels caused by CEDs can be obtained, and interference causation can be determined. This can allow for assessment and changes within a wireless system to reduce and/or eliminate interference which may be caused by the CEDs. A plurality of different interference parameters can be obtained from a plurality of different network nodes, thus allowing for comprehensive analysis and adjustment of a wireless system for an overall interference reduction. Moreover, a certain degree of interference avoidance can be done based on historical patterns, instead of measuring the current interference situation using reference symbols, which can lead to less overhead.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising example network nodes, example coverage enhancing devices, and example wireless devices according to this disclosure,

FIG. 2 is a chart illustrating example temporal interference levels of a wireless communication system according to the disclosure,

FIG. 3 is a flow-chart illustrating an example method, performed by an interference monitoring node, for reducing coverage enhancing device interference according to this disclosure,

FIG. 4 is a block diagram illustrating an example network node according to this disclosure, and

FIG. 5 is a block diagram illustrating an example interference monitoring node according to this disclosure.

### DETAILED DESCRIPTION

Various examples and details are described hereinafter, with reference to the FIGS. when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

Disclosed herein are methods, systems, and network nodes that can be configured to identify interference which may be caused by a coverage enhancing device (CED). For example, methods, systems, and network nodes can be used to monitor interference in one or more cells caused by CEDs and modify a portion of the network in order to reduce interference. For example, the methods, systems, and network nodes can combine interference information from a number of network nodes and, such as via statistical analysis, can determine when, how, and/or why CEDs may be causing interference within a wireless network, and address the interference.

The methods, systems, and network nodes herein can take a particular action to reduce determined interference, such as by modifying configurations of CEDs and/or adjust resource allocation.

As the system can be a 3GPP system, mechanisms for interference handling are used, e.g., based on the Remote Interference Management (RIM) and Crosslink Interference (CLI) frameworks. Different types of interference, such as network node to wireless device, wireless device to wireless device, network node to network node, and wireless device to network node, may be experienced in a system, and counter measures may be different based on the type of interference. The interference may be within the same cell or between different cells, which can also complicate counter measures to reduce interference.

Reflections, such as transmissions, from CEDs may cause interference within a cell of a network node. Reflections, such as transmissions, from CEDs may cause interference within a different cell from the cell of the CEDs. Interference may occur regardless of the status of the CED. For example, a CED may be off, such as inactive, and may still cause interference, such as via passive reflection, such as via scattering. Interference may occur when the CED is on, such as active, such as during reflection, such as transmission, of a signal by a CED. Scattering via passive reflection may be considered transmitting an interference signal, such as transmitting a signal for interference purposes. Reflecting with or without amplification and with or without regenerating the signal, such as with or without a baseband, may be considered transmitting. CEDs may also allow a signal to pass through the device, for example by focusing the signal, which may cause interference.

Components of the disclosed CEDs systems, such as the active components and passive components, can be advantageous to redirect signals, such as to reflect signals, transmit signals, regenerate signals, and/or retransmit signals. For example, the CEDs redirect, such as reflect, transmit, and/or retransmit, an incoming signal from a given incoming direction to a given outgoing direction. Components of the CEDs can be used to redirect, such as reflect, transmit, and/or retransmit, waves and/or signals in the mm wave spectrum, in the sub 7 GHz spectrum, or any other spectrum which may be used. Further, the components of the CEDs can be configured to make redirections of signals which appear in-phase in a certain direction and/or area.

The coverage enhancing devices can be used for network management. The coverage enhancing devices can be used for beam and/or panel management. The coverage enhancing devices can be used for far-field propagation and/or near-field propagation. The coverage enhancing devices can utilize passive fixed array panels, active array panels, and/or intelligent surfaces to improve coverage and beamforming of signals.

The disclosed coverage enhancing devices can be one of a number of different types of devices, which can be used interchangeably herein. For example, the CEDs can be one or more of reconfigurable intelligent surfaces (RISs), large intelligent surfaces (LISs), network configured repeaters, repeater nodes, repeater type devices, repeaters (such as regenerative and/or non-regenerative), intelligent surfaces, and reconfigurable reflective devices (RRDs). The CEDs can have one or more antennas, such as antenna panels, antenna elements, antenna inputs, antenna outputs, and/or unit cells for meta-surfaces. The CEDs can have one or more receivers, for example low-power receivers. The CEDs can have one or more transmitters, such as an active component that provides amplification to a signal.

In one or more example communication systems, the signals disclosed herein can be one or more of: energy, transmission, wave energy, FR1 and FR2 signals, 5G signals, 6G signals, sub-6 GHZ, sub-THz, THz, electromagnetic energy, waves, electromagnetic plane waves, electromagnetic signals, plane signals, spherical waves, spherical signals, cylindrical waves, and cylindrical signals. As disclosed herein, waves and signals can be used interchangeably. Signals can include orbital angular momentum (OAM) signals and/or signals with any polarization properties. The particular type of signal is not limiting.

As disclosed herein, redirecting can include transmitting, reflecting, scattering, re-radiating, directing, and/or retransmitting a signal. Redirecting, transmitting, and retransmitting may be used interchangeably. The redirecting may include altering direction and/or polarization of a signal, and may further include one or more of: amplification, attenuation, termination, phase shifting, delaying, and spatial manipulation of a signal. The redirecting may also add a wave-front of the signal, for example an additional signal can be added to the signal. Spatial manipulation may be, e.g., splitting into multiple components, widening, or in general applying any spatial filtering.

As disclosed herein, the terms signal, message, and data can be used interchangeably.

As used herein, the terms emitted, sent, and transmitted can be used interchangeably.

The figures are schematic and simplified for clarity, and they merely show details which aid understanding the disclosure, while other details have been left out. Throughout, the same reference numerals are used for identical or corresponding parts.

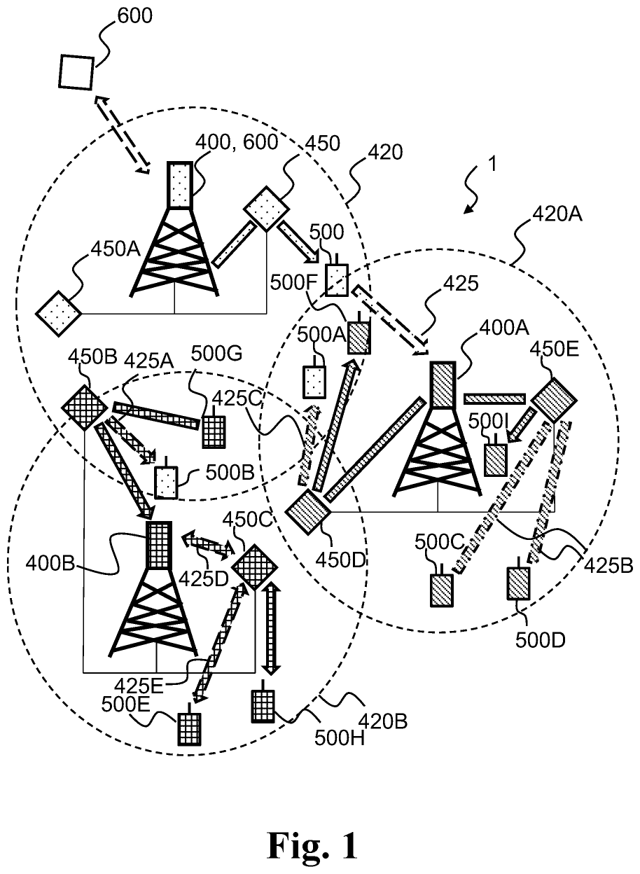

FIG. 1 is a diagram illustrating an example wireless communication system 1. As shown, the system 1 can include at least one example network nodes 400, 400A, 400B, at least one example coverage enhancing devices 450, 450A, 450B, 450C, 450D, 450E and at least one example wireless devices 500, 500A, 500B, 500C, 500D, 500E, 500F, 500G, 500H, 500I according to this disclosure.

As shown, each network node 400, 400A, 400B can include a respective cell 420, 420A, 420B where the network node 400, 400A, 400B can transmit and/or receive signals shown as arrows in FIG. 1. Components within different cells 420, 420A, 420B are hatched to show which devices are within the cells 420, 402A, 420B. Unwanted interference signals 425, 425A, 425B, 425C, 425D, 425E are shown as dashed lines. Unwanted interference signals may be caused by unwanted reflections from the CEDs. Interference signals 425, 425A, and 425C are interferences caused between different cells. Interference signals 425B, 425D, and 425E are interference signals within a cell.

As discussed in detail herein, the present disclosure relates to a wireless communication system 1 comprising a cellular system, for example, a 3GPP wireless communication system.

A wireless device 500 may refer to a mobile device and/or a user equipment, UE. The wireless devices 500 disclosed herein can be one of many types of wireless devices, for example one or more of: a user equipment, a user device, an electronic device, a computer, a tablet, a wireless device, a server, and a smartphone. The particular wireless device 500 is not limiting. The wireless devices 500 disclosed herein may be known as a user equipment.

The wireless device(s) 500, 500A, 500B, 500C, 500D, 500E, 500F, 500G, 500H, 500I may be configured to communicate with the network node 400, 400A, 400B in their respective cell 420, 420A, 420B via a wireless link (or radio access link), shown as arrows in FIG. 1 such as via one or more coverage enhancing devices 450, 450A, 450B, 450C, 450D, 450E.

Disclosed herein is a system 1. In one or more example systems, the system 1 can be configured for reducing signal interference. In one or more example systems, the system 1 can include at least one network node 400. In one or more example systems, the system 1 can include at least one coverage enhancing device 450 within a cell 420 of the at least one network node 400. In one or more example systems, the system 1 can include an interference monitoring node 600 in communication with the at least one network node 400. In one or more example systems, the interference monitoring node 600 is configured to obtain, from the at least one network node 400, an interference parameter associated with the at least one coverage enhancing device 450 capable of transmitting a signal in a cell 420 of the at least one network node 400. In one or more example systems, the interference parameter is indicative of a time stamp of transmission of the signal. In one or more example systems, the interference parameter is indicative of an interference level during transmission of the signal. In one or more example systems, the interference monitoring node 600 is configured to determine, based on the interference parameter, a configuration parameter indicative of a change in resource allocation of the cell 420 and/or a change in coverage enhancing device configuration for reducing the interference level of an upcoming signal. In one or more example systems, the interference monitoring node 600 is configured to provide instructions for the at least one network node 400 to apply the configuration parameter to the upcoming signal transmissions of the at least one coverage enhancing device 450.

The disclosed system 1, such as a wireless communication system, such as an interference monitoring node 600 can utilize a monitoring process that monitors interference reports with respect to CEDs 450 and their associated time stamps through the use of interference parameters. The system 1, such as interference monitoring node 600, can further monitor the current CED configurations associated with the time stamps of the interference reports. Over time, the system 1, such as interference monitoring node 600, can identify, based on interference parameters, CED configurations that show higher risk for interference and may determine configuration parameters based on the interference parameters. In one or more example systems, the system 1, such as interference monitoring node 600, can indicate, such as via instructions to the at least one network node 400 and/or to a CED controller(s), which CED configurations are generating most interference and the interference type. In one or more example systems, the system 1, such as interference monitoring node 600, can determine that there is an interference problem based on the interference parameters. The system 1, such as interference monitoring node 600, can optionally propose a solution for at least one network node 400 to determine the approach to take.

The determination of the CED configurations generating the most interference can allow for a scheduler, such as the at least one network node 400 to, statistically, account for interference mitigations prior to interference, e.g., if the uplink (UL)/downlink (DL) pattern needs to be synchronized between one or more cells 420, or if dedicated time-division duplex (TDD) pattern can be used by a wireless device 500 when it is in an area covered by a CED 450. An at least one network node 400 disclosed herein refers to a radio access network node operating in the radio access network, such as a base station, an evolved Node B, eNB, gNB in NR. In one or more examples, the RAN node is a functional unit which may be distributed in several physical units.

An at least one network node 400 can be configured to transmit and/or receive signals within a cell 420. A cell 420 can be considered a boundary that the at least one network node 400 transmits signals. Adjacent network nodes 400, 400A, 400B, may have overlapping cells 420, 420A, 420B as shown in FIG. 1.

An at least one coverage enhancing device (CED) 450 can be used to transmit, such as retransmit, redirect and/or reflect, a signal in a particular direction based on a coverage enhancing device configuration. An at least one CED 450 can have a plurality of different coverage enhancing device configurations, which can retransmit a signal in a plurality of different directions and/or areas. An at least one CED 450 may be controlled, such as configured, such as a coverage enhancing device configuration, by a network node 400 and/or a high layer server.

An at least one CED 450 can be configured to retransmit a signal from at least one network node 400 to a wireless device 500. An at least one CED 450 can be configured to retransmit a signal from a wireless device 500 to an at least one network node 450. An at least one CED 450 can be configured to retransmit a signal from a wireless device 500 to another wireless device 500A. An at least one CED 450 can be configured to retransmit a signal from at least one network node 400 to another at least one network node 400A.

An at least one CED 450 can be capable of transmitting a signal. An at least one CED 450 can be configurable for transmitting a signal. For example, the at least one CED 450 may have an active configuration where the at least one CED 450 is capable of transmitting a signal. The at least one CED 450 may have an active configuration where the at least one CED 450 is actively transmitting a signal, and is still capable of transmitting a signal. The at least one CED 450 may have an inactive configuration where the at least one CED 450 is capable of transmitting a signal if changed into an active configuration. Scattering which may occur with an inactive at least one CED 450 may also be considered transmitting and/or retransmitting.

The at least one CED 450 may be configured to perform both downlink and uplink transmissions. The at least one CED 450 may be configured to perform uplink transmissions. The at least one CED 450 may be configured to perform both downlink transmissions.

An interference monitoring node 600 may be configured to obtain and/or determine interference parameters, which may also be known as interference reports, interference observations, interference measurements. The interference monitoring node 600 may be configured to obtain an interference parameter from one or more network nodes, such as at least one network node 400. The interference monitoring node 600 may be configured to obtain an interference parameter from a single network node. The interference monitoring node 600 may be configured to obtain an interference parameter from a plurality of network nodes. The interference monitoring node 600 may be a node in communication with one or more of the at least one network node 400. As shown in FIG. 1, the interference monitoring node 600 is in communication with at least one network node 400. While not shown in FIG. 1, interference monitoring node 600 can also be in communication with at least one network node 400A and/or at least one network node 400B.

The interference monitoring node 600 may be a server. The interference monitoring node 600 may be a back end server. The interference monitoring node 600 may be a spectrum access server (SAS).

In one or more example systems, the interference monitoring node 600 comprises an interference monitoring server in the core network and/or a cloud server.

In one or more example systems, the system 1 can include more than one interference monitoring node 600. The plurality of interference monitoring nodes can be in communication with one another. The plurality of interference monitoring nodes can share information, such as one or more of the interference parameter, the configuration parameter, and the instructions. Each of the plurality of interference monitoring nodes can be configured to obtain an interference parameter from a subset of network nodes. A first interference monitoring node can obtain interference parameters from a first subset of at least one network node. A second interference monitoring node can obtain interference parameters from a second subset of at least one network node. The first subset may be mutually exclusive from the second subset. The first subset may partially overlap with the second subset.

The interference monitoring node 600 can be a core network, CN, node. A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME.

In one or more example systems, the interference monitoring node 600 comprises the at least one network node 400.

For example, the at least one network node 400 can act as the interference monitoring node 600. The at least one network node 400 can act as the interference monitoring node for a single cell 420 and/or for multiple cells 420, 420A, 420B.

In one or more example systems, the interference monitoring node 600 can include one or more network nodes, such as one or more of the at least one network node 400.

The interference monitoring node 600 can be configured to receive an interference parameter. The interference parameter may be associated with at least one CED 450. The interference parameter may be associated with at least one CED configuration. Each of the at least one CEDs 450 may have an associated interference parameter. Generally, the interference parameter can be indicative of interference caused by the at least one CED 450.

The interference parameter can be indicative of a time stamp, such as a time, of transmission of a signal. The interference parameter can be indicative of a time stamp of transmission of the signal by the at least one CED 450. The interference parameter can be indicative of a time stamp of transmission of the signal by the at least one network node 400. The interference parameter can be indicative of a time stamp of transmission of the signal by a wireless device 500.

The interference parameter can be indicative of an interference level during transmission of the signal. The interference parameter can be indicative of an interference level experienced in the cell 420 containing the at least one CED 450 during transmission of the signal. The interference parameter can be indicative of an interference level experienced in the cell 420A not-containing the at least one CED 450 during transmission of the signal. The interference level may be experienced by one or more of the at least one network node 400, the at least one CED 450, and the wireless device 500.

In one or more example systems, the interference parameter is indicative of a configuration of the at least one coverage enhancing device 450. In one or more example systems, the interference parameter is indicative of a signal type of the signal.

For example, the at least one CED 450 can have a plurality of coverage enhancing devices configurations. The interference parameter can be indicative of the particular configuration that the at least one CED 450 is in at the time of signal transmission. The interference parameter can be indicative of the particular configuration that the at least one CED 450 is in at the time of signal transmission from the at least one CED 450. The interference parameter can be indicative of the particular configuration that the at least one CED 450 is in at the time of signal transmission from the at least one network node 400. The interference parameter can be indicative of the particular configuration that the at least one CED 450 is in at the time of signal transmission from a wireless device 500.

The interference parameter can be indicative of a signal type of the signal. For example, the signal type may be one or more of a downlink signal, an uplink signal, and a sidelink signal.

The interference parameter can be indicative of one or more of: interference presence, interference level, communication type UL/DL, interference exposed node (wireless device 500 and/or at least one network node 400), interference exposed cell (intra-cell and/or inter-cell), bandwidth part exposed to interference (a range of the frequency spectrum that is exposed to interference), time of interference (such as time stamp), time pattern of interference, at least one CED configuration (ON state, OFF state, direction, beam width, gain), at least one network node 450 configuration (what TRP, beam configuration), and at least one network node 450 operation (e.g., during SSB transmission).

The interference monitoring node 600 can be configured to determine, based on the interference parameter, a configuration parameter. The configuration parameter may be used by the system 1, such as by the interference monitoring node 600, to reduce interference for an upcoming signal. An upcoming signal may be a future signal that has not been transmitted yet. The interference monitoring node 600 may be configured to compare interference parameters from a plurality of network nodes 400, 400A to determine the configuration parameter. The interference monitoring node 600 may be configured to determine the configuration parameter from a single network node 400.

The configuration parameter can be indicative of a change in resource allocation of the cell. For example, the configuration parameter can be indicative of a change in timing for resource allocation of the cell. The configuration parameter can be indicative of an adjustment of uplink and/or downlink signals.

The configuration parameter can be indicative of a change in coverage enhancing device configuration. For example, the configuration parameter can be indicative of a change in the at least one CED 450 from a first configuration to a second configuration, such as an updated configuration.

The interference monitoring node 600 can be configured to provide instructions for the at least one network node 400 to apply the configuration parameter. As the at least one network node 400 may be the interference monitoring node 600, the at least one network node 400 can be configured to apply the configuration parameter. The at least one network node 400 can be configured to receive instructions from the interference monitoring node 600.

The at least one network node 400 can be configured to apply the configuration parameter to the upcoming signal transmission, for example transmission of the upcoming signal, of the at least one CED 450.

In one or more example systems, applying the configuration parameter comprises providing an updated resource allocation to the at least one network node 400.

As a particular resource allocation may be causing interference, the interference monitoring node 600 may be configured to provide instructions for the at least one network node 400 to apply an updated resource allocation.

In one or more example systems, providing instructions to apply the configuration parameter comprises providing instructions for the at least one network node 400 to apply an updated configuration to the at least one coverage enhancing device 450.

For example, the updated configuration parameter, when applied, can cause a change in the at least one CED 450 from a first configuration to an updated configuration.

In one or more example systems, providing instructions to apply the configuration comprises providing instructions for the at least one network node to synchronize time-division duplex (TDD) configurations in the cell 450 with a second cell 450A.

In one or more example systems, providing instructions to apply the configuration comprises providing instructions for the at least one network node to synchronize frequency-division duplex (FDD) configurations in the cell 450 with a second cell 450A. The second cell 450A may be adjacent to the cell 450. The second cell 450A may not be adjacent to the cell 450. The signals within the cell 450 and the second cell 450A can be synchronized so that the signals within the cells 450, 450A do not cause, or cause a reduced amount of, interference with one another. For example, synchronizing configurations in the cell 450 with a second cell 450A can include time synchronization and/or synchronizing FDD and/or TDD UL/DL frame structure.

In one or more example systems, the interference level is indicative of one or more of: network node-to-network node interference, network node-to-user equipment interference, user equipment-to-network node interference, and user equipment-to-user equipment interference.

For example, network node-to-network node interference may be interference experienced due to unintended signal transmissions between at least one of the network nodes 400 and another of the at least one network nodes 400A.

For example, network node-to-user equipment interference may be interference experienced due to unintended signal transmissions between the at least one network node 400 and a wireless device 500, such as a user equipment.

For example, user equipment-to-network node interference may be interference experienced due to unintended signal transmissions between a wireless device 500, such as a user equipment, and at least one network node 400.

For example, user equipment-to-user equipment interference may be interference experienced due to unintended signal transmissions between a wireless device 500, such as a user equipment, and a second wireless device 500A.

The interface monitoring node 600 can be configured to determine, based on the interference parameter, the type of interference and/or distinguish between different types of interference.

In one or more example systems, the interference level is indicative of one or more of cross-link interference, remote interference, inter-cell interference, and intra-cell interference.

Cross-link interference can occur when network nodes 400, 400A interfere with each other as they transmit and/or receive signals in the same frequency band due to mismatched TDD slot configurations.

Remote interference may be interference that occurs during specific atmospheric conditions, such that a downlink transmission from a first cell interferes with an uplink transmission of a second cell far away from the first cell.

Inter-cell interference may be interference experienced between two cells 420, 420A.

Intra-cell interference may be interference experienced within a cell 420.

FIG. 1 illustrates potential situations where interference may occur in the system 1. Table I below illustrates potential scenarios at different times. Each CED 450, 450A, 450B, 450C, 450D, 450E can have a particular configuration: a, b, c, d, e, f, g.

TABLE I
Example interferences

| Time | Event | Signal type | CED configuration |
|---|---|---|---|
| T1 | Network node 400 | DL | CED 450: a |
| | to network node | X dBm | CED 450A: c |
| | 400B | | |
| T2 | Wireless device | UL | CED 450B: e |
| | 500E to network | Y dBm | CED 450C: f |
| | node 400B | | |
| T3 | Network node 400B | DL | CED 450B: g |
| | to wireless device | Z dBm | CED 450C: f |
| | 500E | | |
| T4 | Network node 400A | DL | CED 450B: d |
| | to wireless device | K dBm | CED 450C: b |
| | 500A | | |
| T5 | Wireless device | UL | CED 450D: a |
| | 500C to wireless | L dBm | CED 450E: f |
| | device 500D | | |

In one or more example systems, obtaining the interference parameter comprises obtaining, from a plurality of network nodes, interference parameters of a plurality of coverage enhancing devices located in one or more cells of the plurality of network nodes. In one or more example systems, determining the configuration parameter is based on the interference parameters from the plurality of network nodes.

For example, the interference monitoring node 600 may receive interference parameters from many different network nodes of the at least one network node 400. By receiving interference parameters from a plurality of different network nodes, the interference monitoring node 600 can determine the configuration parameter based on all of the different interference parameters.

For example, the interference monitoring node 600 may be able to coordinate CED configurations and/or resource allocations for tens, hundreds, or thousands of network nodes. By obtaining more interference parameters, the interference monitoring node 600 may be able to better determine configuration parameters that can alleviate and/or reduce interference over an entire network including many network nodes.

In one or more example systems, determining the configuration parameter comprises to applying, based on the interference parameter, a statistical model and/or a machine learning model to the interference parameter.

For example, the configuration parameter can be determined statistically, such as based on interference levels and time stamps of the interference parameter. The interference monitoring node 600 can obtain the interference parameter for multiple time stamps, and optionally multiple network nodes 400. The interference monitoring node 600 can then use the multiple interference parameters in a statistical determination of the configuration parameter.

For example, the configuration parameter can be determined via machine learning, such as based on interference levels and time stamps of the interference parameter. The interference monitoring node 600 can obtain the interference parameter for multiple time stamps, and optionally multiple network nodes 400. The interference monitoring node 600 can then use the multiple interference parameters as input into a machine learning model for a determination of the configuration parameter.

Example inputs into a machine learning model can include one or more of interference presence, interference level, communication type UL/DL, interference exposed node (wireless device 500/at least one network node 400), interference exposed cell (intra-cell/inter-cell), bandwidth part exposed to interference (a range of the frequency spectrum that is exposed to interference), time of interference (such as time stamp), time pattern of interference, at least one CED configuration (ON state, OFF state, direction, beam width, gain), at least one network node 450 configuration (what TRP, beam configuration), and at least one network node 450 operation (e.g. during SSB transmission).

The interference monitoring node 600 may be configured to obtain a plurality of interference parameters, such as thousands, millions, or billions of interference parameters. The machine learning model may be configured to determine whether a CED configuration is in fact causing interference or not. The machine learning model may be configured to determine what level of interference a CED configuration is causing and/or when a CED configuration is causing interference.

In one or more example systems, determining the configuration parameter comprises to determining, based on the interference parameter, a risk parameter indicative of potential interference risk of the upcoming signal. In one or more example systems, the configuration parameter is based on the risk parameter.

The configuration parameter may be based on a risk parameter. The interference monitoring node 600 can determine a risk parameter, such as based on the interference parameter. The interference monitoring node 600 may assess a probability of risk of interference for a CED configuration and/or resource allocation that the interference monitoring node 600 has not obtained an interference parameter for.

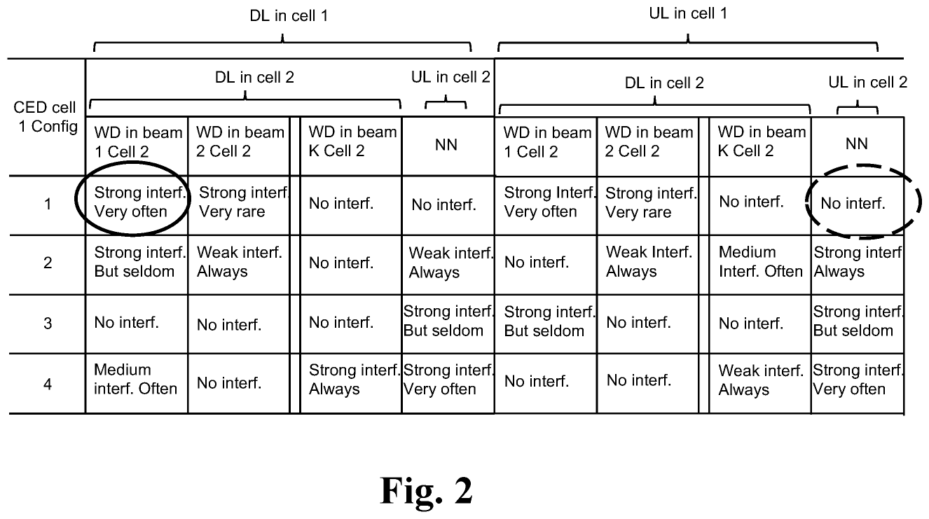

FIG. 2 illustrates an example of a monitoring process according to the disclosure. For convenience's sake, FIG. 2 does not include real-time temporal or bandwidth aspects.

FIG. 2 illustrates the end result of the monitoring process corresponding to the interference in cell 2 due to the CED of cell 1. For example, cell 1 may correspond to cell 420, cell 2 may correspond to cell 420A, and the CED may correspond to CED 450 of FIG. 1. NN is the at least one network node 400 and WD is a wireless device 500.

In this example, the CED 450 can be in one out of four configured states, though more or less number of configurations can be used. The interference monitoring node 600 can be configured to separate between if there is uplink or downlink transmission in cell 1 420 (left and right halves of FIG. 2) as indicated by an interference parameter.

For each choice, the interference monitoring node 600 can separate between uplink and downlink transmission in cell 2 as indicated by an interference parameter.

The state highlighted by the solid circled box has the following meaning: If the CED 450 is in state 1 and there is DL traffic in both cell 1 and 2, then a WD 500 in NN beam 1 of cell 2 will “very often” have “strong” interference. This means that that there is NN-WD interference. The state highlighted by the dashed circled box has the following meaning: If the CED 450 is in state 1 and there is UL traffic in both cell 1 and 2, then the NN of cell 2 has never been interfered with. Thus, there is no WD-NN interference.

By means of the table of FIG. 2, or some other form of data presentation method, the interference monitoring node 600 is able to determine under which circumstances interference is detected and attempt to reduce or remove said interference.

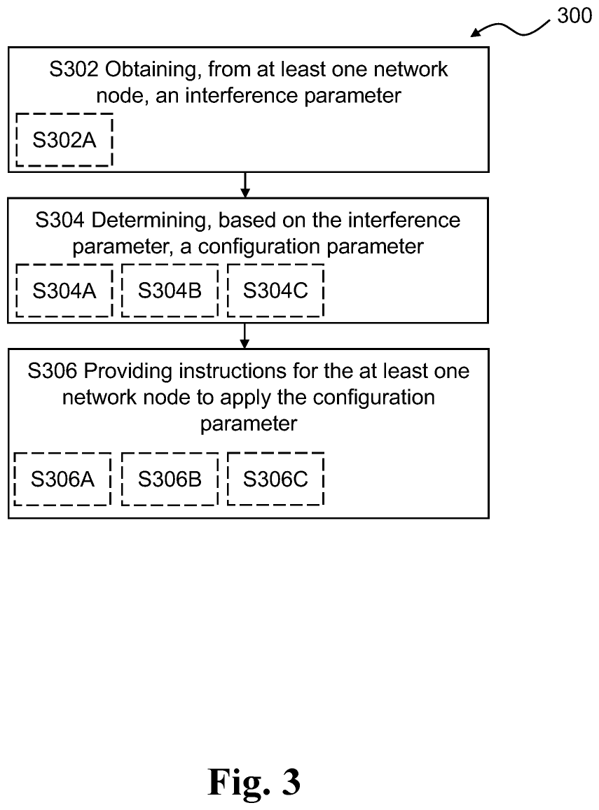

FIG. 3 shows a flow diagram of an example method 300, performed by an interference monitoring node according to the disclosure, for reducing interference. The interference monitoring node is the interference monitoring node 600 and/or network node 400 of FIG. 1.

The method 300 comprises obtaining S302, from at least one network node, an interference parameter associated with at least one coverage enhancing device capable of transmitting a signal in a cell of the at least one network node. In one or more example methods, the interference parameter is indicative of a time stamp of transmission of the signal. In one or more example methods, the interference parameter is indicative of an interference level during transmission of the signal. The method 300 comprises determining S304, based on the interference parameter, a configuration parameter indicative of a change in resource allocation of the cell and/or a change in coverage enhancing device configuration for reducing the interference level of an upcoming signal. The method 300 comprises providing S306 instructions for the at least one network node to apply the configuration parameter to the upcoming signal transmissions of the at least one coverage enhancing device.

An at least one coverage enhancing device (CED) can be used to transmit, such as retransmit, redirect and/or reflect, a signal in a particular direction based on a coverage enhancing device configuration. An at least one CED can have a plurality of different coverage enhancing device configurations, which can retransmit a signal in a plurality of different directions and/or areas. An at least one CED may be controlled, such as configured, such as a coverage enhancing device configuration, by a network node and/or a high layer server.

The interference parameter may be associated with at least one CED. The interference parameter may be associated with at least one CED configuration. Each of the at least one CEDs may have an associated interference parameter. Generally, the interference parameter can be indicative of interference caused by the at least one CED.

The interference parameter can be indicative of one or more of: interference presence, interference level, communication type UL/DL, interference exposed node (wireless device and/or at least one network node), interference exposed cell (intra-cell and/or inter-cell), bandwidth part exposed to interference (a range of the frequency spectrum that is exposed to interference), time of interference (such as time stamp), time pattern of interference, at least one CED configuration (ON state, OFF state, direction, beam width, gain), at least one network node configuration (what TRP, beam configuration), and at least one network node operation (e.g., during SSB transmission).

The configuration parameter can be indicative of a change in resource allocation of the cell. For example, the configuration parameter can be indicative of a change in timing for resource allocation of the cell. The configuration parameter can be indicative of an adjustment of uplink and/or downlink signals. The configuration parameter can be indicative of a change in coverage enhancing device configuration. For example, the configuration parameter can be indicative of a change in the at least one CED from a first configuration to a second configuration, such as an updated configuration.

In one or more example methods, the interference monitoring node comprises an interference monitoring server in the core network and/or a cloud server.

An interference monitoring node may be configured for obtaining and/or determining interference parameters, which may also be known as interference reports, interference observations, interference measurements. The interference monitoring node may be configured for obtaining an interference parameter from one or more network nodes, such as at least one network node.

In one or more example methods, the interference monitoring node comprises the at least one network node.

For example, the at least one network node can act as the interference monitoring node. The at least one network node can act as the interference monitoring node for a single cell and/or for multiple cells. In other words, a network node, such as a base station, can perform monitoring of interference within its own cell but also obtain transmission/interference information from neighbouring cells to aid in interference management.

In one or more example methods, the interference level is indicative of one or more of: network node-to-network node interference, network node-to-user equipment interference, user equipment-to-network node interference, and user equipment-to-user equipment interference.

In one or more example methods, the interference level is indicative of one or more of cross-link interference, remote interference, inter-cell interference, and intra-cell interference.

For example, the interference parameter may be indicative that atmospheric ducting is occurring, which may enable remote interference. Cross-link interference can occur when network nodes interfere with each other as they transmit and/or receive signals in the same frequency band due mismatched TDD slot configurations. Remote interference may be interference that occurs during specific atmospheric condition, such that a downlink transmission from a first cell interferes with an uplink transmission of a second cell far away from the first cell. Inter-cell interference may be interference experienced between two cells. Intra-cell interference may be interference experienced within a cell.

In one or more example methods, obtaining S302 the interference parameter comprises obtaining S302A, from a plurality of network nodes, interference parameters of a plurality of coverage enhancing devices located in one or more cells of the plurality of network nodes. In one or more example methods, determining S304A the configuration parameter is based on the interference parameters from the plurality of network nodes.

For example, the interference monitoring node may be obtaining interference parameters from many different network nodes of the at least one network node. By receiving interference parameters from a plurality of different network nodes, the interference monitoring node can be determining the configuration parameter based on all of the different interference parameters.

For example, the method 300 can allow for the interference monitoring node to be able to coordinate CED configurations and/or resource allocations for tens, hundreds, or thousands of network nodes.

In one or more example methods, determining S304 the configuration parameter comprises applying S304B, based on the interference parameter, a statistical model and/or a machine learning model to the interference parameter.

For example, the configuration parameter can be determined by applying a statistical model, such as based on interference levels and time stamps of the interference parameter. For example, the configuration parameter can be determined by applying machine learning, such as based on interference levels and time stamps of the interference parameter.

In one or more example methods, determining S304 the configuration parameter comprises determining S304C, based on the interference parameter, a risk parameter indicative of potential interference risk of the upcoming signal. In one or more example methods, the configuration parameter is based on the risk parameter.

For example, the instructions can be indicative for the network node to transmit with a certain configuration if interference have never been seen with that configuration, e.g., the risk is zero with the risk-notation.

In one or more example methods, providing S306 instructions for the at least one network node to apply the configuration parameter comprises providing S306A an updated resource allocation to the at least one network node.

For example, the method 300 may allow for the at least one network node to apply an updated resource allocation in order to reduce interference.

For example, when the interference management node is embodied by the network node, such as a base station, the network node may adjust an uplink resource (e.g. PUSCH or PUCCH) of a wireless device within its cell in order to avoid causing interference at another wireless device or network node.

In one or more example methods, providing S306 instructions to apply the configuration parameter comprises providing S306B instructions for the at least one network node to apply an updated configuration to the at least one coverage enhancing device.

For example, the method 300 may allow for the at least one network node to apply an updated configuration to the at least one CED in order to reduce interference.

For example, when the interference management node is embodied by a core network node, it might indicate to a network node that a wireless device within its cell is causing interference during a currently scheduled UL resource. The network node will then be able to adjust the UL resource of the particular wireless device in order to aid in reducing the interference issues.

In one or more example methods, providing S306 instructions to apply the configuration comprises providing S306C instructions for the at least one network node to synchronize time-division duplex (TDD) configurations in the cell with a second cell.

For example, the instructions can include instructions so that both network nodes schedule UL resources at the same and/or similar times within their respective cells.

In one or more example methods, providing S306 instructions to apply the configuration comprises providing instructions for the at least one network node to synchronize frequency-division duplex (FDD) configurations in the cell with a second cell.

In one or more example methods, the interference parameter is indicative of a configuration of the at least one coverage enhancing device. In one or more example methods, the interference parameter is indicative of a signal type of the signal. For example, the type of signal can be a UL signal or a DL signal.

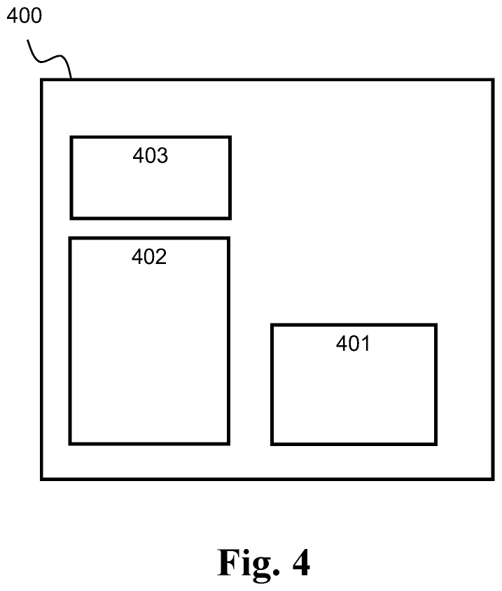

FIG. 4 shows a block diagram of an example network node 400 according to the disclosure. The network node 400 comprises memory circuitry 401, processor circuitry 402, and a wireless interface 403. The network node 400 may be configured to perform any of the methods disclosed in FIG. 3.

The network node 400 is configured to communicate with wireless devices, such as via a coverage enhancing device disclosed herein.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed and/or unlicensed bands, such as device-to-device millimeter-wave communications in licensed bands.

Processor circuitry 402 is optionally configured to perform any of the operations disclosed in FIG. 3 (such as any one or more of S302, S304, S306, 302A, 304A, 304B, 304C, 306A, 306B, 306C). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 4). Memory circuitry 401 is considered a non-transitory computer readable medium.

Disclosed herein is a network node 400. In one or more example network nodes, the network node 400 can be configured to reduce signal interference. In one or more example network nodes, the network node 400 comprises memory circuitry 401. In one or more example network nodes, the network node 400 comprises a wireless interface 403. In one or more example network nodes, the network node 400 comprises processor circuitry 402. In one or more example network nodes, the processor circuitry 402 is configured to provide, to an interference monitoring node, an interference parameter associated with the at least one coverage enhancing device capable of transmitting a signal in a cell of the network node. In one or more example network nodes, the interference parameter is indicative of a time stamp of transmission of the signal. In one or more example network nodes, the interference parameter is indicative of an interference level during transmission of the signal. In one or more example network nodes, the processor circuitry 402 is configured to receive, based on the interference parameter, a configuration parameter indicative of a change in resource allocation of the cell and/or a change in coverage enhancing device configuration for reducing the interference level of an upcoming signal. In one or more example network nodes, the processor circuitry 402 is configured to apply the configuration parameter to the upcoming signal transmissions of the at least one coverage enhancing device.

In one or more example network nodes, the interference monitoring node comprises an interference monitoring server in the core network and/or a cloud server.

In one or more example network nodes, the interference level is indicative of one or more of: network node-to-network node interference, network node-to-user equipment interference, user equipment-to-network node interference, and user equipment-to-user equipment interference.

In one or more example network nodes, the interference level is indicative of one or more of cross-link interference, remote interference, inter-cell interference, and intra-cell interference.

In one or more example network nodes, applying the configuration parameter comprises applying an updated resource allocation.

In one or more example network nodes, applying the configuration parameter comprises applying an updated configuration to the at least one coverage enhancing device.

In one or more example network nodes, applying the configuration comprises synchronizing time-division duplex (TDD) configurations in the cell with a second cell.

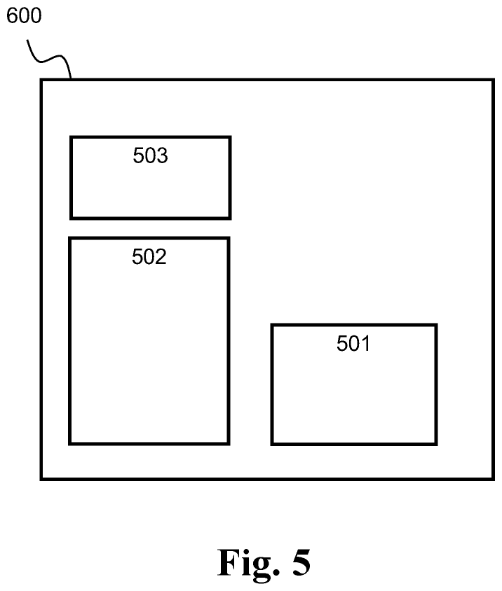

FIG. 5 shows a block diagram of an example interference monitoring node 600 according to the disclosure. The interference monitoring node 600 comprises memory circuitry 501, processor circuitry 502, and a wireless interface 503. The interference monitoring node 600 may be configured to perform any of the methods disclosed in FIG. 3. The interference monitoring node 600 can be the same as the network node 400 disclosed in FIG. 4.

The interference monitoring node 600 is configured to communicate with at least one network node.

The wireless interface 503 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed and/or unlicensed bands, such as device-to-device millimeter-wave communications in licensed bands.

Processor circuitry 502 is optionally configured to perform any of the operations disclosed in FIG. 3 (such as any one or more of S302, S304, S306, 302A, 304A, 304B, 304C, 306A, 306B, 306C). The operations of the interference monitoring node 600 may be embodied in the form of executable logic routines (for example, lines of code, software programs, etc.) that are stored on a non-transitory computer readable medium (for example, memory circuitry 501) and are executed by processor circuitry 502).

Furthermore, the operations of the interference monitoring node 600 may be considered a method that the interference monitoring node 600 is configured to carry out. Also, while the described functions and operations may be implemented in software, such functionality may also be carried out via dedicated hardware or firmware, or some combination of hardware, firmware and/or software.

Memory circuitry 501 may be one or more of a buffer, a flash memory, a hard drive, a removable media, a volatile memory, a non-volatile memory, a random access memory (RAM), or other suitable device. In a typical arrangement, memory circuitry 501 may include a non-volatile memory for long term data storage and a volatile memory that functions as system memory for processor circuitry 502. Memory circuitry 501 may exchange data with processor circuitry 502 over a data bus. Control lines and an address bus between memory circuitry 501 and processor circuitry 502 also may be present (not shown in FIG. 5). Memory circuitry 501 is considered a non-transitory computer readable medium.

An interference monitoring node 600 configured to reduce signal interference is provided. The interference monitoring node 600 comprises memory circuitry 501. The interference monitoring node 600 comprises a wireless interface 503. The interference monitoring node 600 comprises processor circuitry 502. The processor circuitry 502 is configured to obtain an interference parameter associated with the at least one coverage enhancing device capable of transmitting a signal in a cell of at least one network node. The interference parameter is indicative of a time stamp of transmission of the signal. The interference parameter is indicative of an interference level during transmission of the signal. The processor circuitry 502 is configured to determine, based on the interference parameter, a configuration parameter indicative of a change in resource allocation of the cell and/or a change in coverage enhancing device configuration for reducing the interference level of an upcoming signal. The processor circuitry 502 is configured to provide instructions for the at least one network node to apply the configuration parameter to the upcoming signal transmissions of the at least one coverage enhancing device.

Examples of methods and products (system, interference monitoring node, and network node) according to the disclosure are set out in the following items:
Item 1. A method, performed by an interference monitoring node, the method comprising:
   obtaining, from at least one network node, an interference parameter associated with at least one coverage enhancing device capable of transmitting a signal in a cell of the at least one network node, wherein the interference parameter is indicative of:
      a time stamp of transmission of the signal; and
      an interference level during transmission of the signal;
   determining, based on the interference parameter, a configuration parameter indicative of a change in resource allocation of the cell and/or a change in coverage enhancing device configuration for reducing the interference level of an upcoming signal; and
   providing instructions for the at least one network node to apply the configuration parameter to the upcoming signal transmissions of the at least one coverage enhancing device.
Item 2. Method of Item 1, wherein the interference monitoring node comprises an interference monitoring server in the core network and/or a cloud server.
Item 3. Method of Item 1, wherein the interference monitoring node comprises the at least one network node.
Item 4. Method of any one of the previous Items, wherein the interference level is indicative of one or more of: network node-to-network node interference, network node-to-user equipment interference, user equipment-to-network node interference, and user equipment-to-user equipment interference.
Item 5. Method of any one of the previous Items, wherein the interference level is indicative of one or more of cross-link interference, remote interference, inter-cell interference, and intra-cell interference.
Item 6. Method of any one of the previous Items, wherein:
   obtaining the interference parameter comprises obtaining, from a plurality of network nodes, interference parameters of a plurality of coverage enhancing devices located in one or more cells of the plurality of network nodes, and
   determining the configuration parameter is based on the interference parameters from the plurality of network nodes.
Item 7. Method of any one of the previous Items, wherein determining the configuration parameter comprises applying, based on the interference parameter, a statistical model and/or a machine learning model to the interference parameter.
Item 8. Method of any of the previous Items, wherein determining the configuration parameter comprises:
   determining, based on the interference parameter, a risk parameter indicative of potential interference risk of the upcoming signal;
   wherein the configuration parameter is based on the risk parameter.
Item 9. Method of any one of the previous Items, wherein providing instructions for the at least one network node to apply the configuration parameter comprises providing an updated resource allocation to the at least one network node.
Item 10. Method of any one of Items 1-8, wherein providing instructions to apply the configuration parameter comprises providing instructions for the at least one network node to apply an updated configuration to the at least one coverage enhancing device.
Item 11. Method of any one of the previous Items, wherein providing instructions to apply the configuration comprises providing instructions for the at least one network node to synchronize time-division duplex (TDD) configurations in the cell with a second cell.
Item 12. Method of any one of the previous Items, wherein the interference parameter is indicative of:
   a configuration of the at least one coverage enhancing device; and
   a signal type of the signal.
Item 13. A system for reducing signal interference, the system comprising:
   at least one network node;
   at least one coverage enhancing device within a cell of the at least one network node; and
   an interference monitoring node in communication with the at least one network node, wherein the interference monitoring node is configured to:
      obtain, from the at least one network node, an interference parameter associated with the at least one coverage enhancing device capable of transmitting a signal in a cell of the at least one network node, wherein the interference parameter is indicative of:
         a time stamp of transmission of the signal; and
         an interference level during transmission of the signal;
      determine, based on the interference parameter, a configuration parameter indicative of a change in resource allocation of the cell and/or a change in coverage enhancing device configuration for reducing the interference level of an upcoming signal; and
      provide instructions for the at least one network node to apply the configuration parameter to the upcoming signal transmissions of the at least one coverage enhancing device.
Item 14. System of Item 13, wherein the interference monitoring node comprises an interference monitoring server in the core network and/or a cloud server.
Item 15. System of Items 13, wherein the interference monitoring node comprises the at least one network node.
Item 16. System of any one of Items 13-15, wherein the interference level is indicative of one or more of: network node-to-network node interference, network node-to-user equipment interference, user equipment-to-network node interference, and user equipment-to-user equipment interference.
Item 17. System of any one of Items 13-16, wherein the interference level is indicative of one or more of cross-link interference, remote interference, inter-cell interference, and intra-cell interference.
Item 18. System of any one of Items 13-17, wherein:
   to obtain the interference parameter comprises to obtain, from a plurality of network nodes, interference parameters of a plurality of coverage enhancing devices located in one or more cells of the plurality of network nodes, and
   to determine the configuration parameter is based on the interference parameters from the plurality of network nodes.
Item 19. System of any one of Items 13-18, wherein to determine the configuration parameter comprises to apply, based on the interference parameter, a statistical model and/or a machine learning model to the interference parameter.
Item 20. System of any one of Items 13-19, wherein to determine the configuration parameter comprises:
   to determine, based on the interference parameter, a risk parameter indicative of potential interference risk of the upcoming signal;
   wherein the configuration parameter is based on the risk parameter.
Item 21. System of any one of Items 13-20, wherein to apply the configuration parameter comprises to provide an updated resource allocation to the at least one network node.
Item 22. System of any one of Items 13-20, wherein to provide instructions to apply the configuration parameter comprises to provide instructions for the at least one network node to apply an updated configuration to the at least one coverage enhancing device.
Item 23. System of any one of Items 13-22, wherein to provide instructions to apply the configuration comprises to provide instructions for the at least one network node to synchronize time-division duplex (TDD) configurations in the cell with a second cell.
Item 24. System of any one of Items 13-23, wherein the interference parameter is indicative of:
   a configuration of the at least one coverage enhancing device; and
   a signal type of the signal.
Item 25. A network node configured to reduce signal interference, the network node comprising:
   memory circuitry;
   a wireless interface; and
   processor circuitry, wherein the processor circuitry is configured to:
      provide, to an interference monitoring node, an interference parameter associated with the at least one coverage enhancing device capable of transmitting a signal in a cell of the network node, wherein the interference parameter is indicative of:
         a time stamp of transmission of the signal; and
         an interference level during transmission of the signal;
      receive, based on the interference parameter, a configuration parameter indicative of a change in resource allocation of the cell and/or a change in coverage enhancing device configuration for reducing the interference level of an upcoming signal; and
      apply the configuration parameter to the upcoming signal transmissions of the at least one coverage enhancing device.
Item 26. Network node of Item 25, wherein the interference monitoring node comprises an interference monitoring server in the core network and/or a cloud server.
Item 27. Network node of any one of Items 25-26, wherein the interference level is indicative of one or more of: network node-to-network node interference, network node-to-user equipment interference, user equipment-to-network node interference, and user equipment-to-user equipment interference.
Item 28. Network node of any one of Items 25-27, wherein the interference level is indicative of one or more of cross-link interference, remote interference, inter-cell interference, and intra-cell interference.
Item 29. Network node of any one of Items 25-28, wherein to apply the configuration parameter comprises to apply an updated resource allocation.
Item 30. Network node of any one of Items 25-29, wherein to apply the configuration parameter comprises to apply an updated configuration to the at least one coverage enhancing device.
Item 31. Network node of any one of Items 25-30, wherein to apply the configuration comprises to synchronize time-division duplex (TDD) configurations in the cell with a second cell.
Item 32. Network node of any one of Items 25-31, wherein the interference parameter is indicative of:
   a configuration of the at least one coverage enhancing device; and
   a signal type of the signal.
Item 33. An interference monitoring node configured to reduce signal interference, the interference monitoring node comprising:
   memory circuitry;
   a wireless interface; and
   processor circuitry, wherein the processor circuitry is configured to:
      obtain an interference parameter associated with the at least one coverage enhancing device capable of transmitting a signal in a cell of at least one network node, wherein the interference parameter is indicative of:
         a time stamp of transmission of the signal; and
         an interference level during transmission of the signal;
      determine, based on the interference parameter, a configuration parameter indicative of a change in resource allocation of the cell and/or a change in coverage enhancing device configuration for reducing the interference level of an upcoming signal; and
      provide instructions for the at least one network node to apply the configuration parameter to the upcoming signal transmissions of the at least one coverage enhancing device.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by an interference monitoring node, the method comprising:
obtaining, from at least one network node, an interference parameter associated with at least one coverage enhancing device capable of transmitting a signal in a cell of the at least one network node, wherein the interference parameter is indicative of:
a time stamp of transmission of the signal; and
an interference level during transmission of the signal;
determining, based on the interference parameter, a configuration parameter indicative of a change in resource allocation of the cell and/or a change in coverage enhancing device configuration for reducing the interference level of an upcoming signal; and
providing instructions for the at least one network node to apply the configuration parameter to the upcoming signal transmissions of the at least one coverage enhancing device.

2. The method of claim 1, wherein the interference monitoring node comprises an interference monitoring server in the core network and/or a cloud server, or wherein the interference monitoring node comprises the at least one network node.

3. The method of claim 1, wherein the interference level is indicative of one or more of: network node-to-network node interference, network node-to-user equipment interference, user equipment-to-network node interference, and user equipment-to-user equipment interference.

4. The method of claim 1, wherein the interference level is indicative of one or more of cross-link interference, remote interference, inter-cell interference, and intra-cell interference.

5. The method of claim 1, wherein:
obtaining the interference parameter comprises obtaining, from a plurality of network nodes, interference parameters of a plurality of coverage enhancing devices located in one or more cells of the plurality of network nodes, and
determining the configuration parameter is based on the interference parameters from the plurality of network nodes.

6. The method of claim 1, wherein determining the configuration parameter comprises applying, based on the interference parameter, a statistical model and/or a machine learning model to the interference parameter.

7. The method of claim 1, wherein determining the configuration parameter comprises:
determining, based on the interference parameter, a risk parameter indicative of potential interference risk of the upcoming signal;
wherein the configuration parameter is based on the risk parameter.

8. The method of claim 1, wherein providing instructions for the at least one network node to apply the configuration parameter comprises providing an updated resource allocation to the at least one network node.

9. The method of claim 1, wherein providing instructions to apply the configuration parameter comprises providing instructions for the at least one network node to apply an updated configuration to the at least one coverage enhancing device.

10. The method of claim 1, wherein providing instructions to apply the configuration comprises providing instructions for the at least one network node to synchronize time-division duplex (TDD) configurations in the cell with a second cell.

11. The method of claim 1, wherein the interference parameter is indicative of:
a configuration of the at least one coverage enhancing device; and
a signal type of the signal.

12. A system for reducing signal interference, the system comprising:
at least one network node;
at least one coverage enhancing device within a cell of the at least one network node; and
an interference monitoring node in communication with the at least one network node, wherein the interference monitoring node is configured to:
obtain, from the at least one network node, an interference parameter associated with the at least one coverage enhancing device capable of transmitting a signal in a cell of the at least one network node, wherein the interference parameter is indicative of:
a time stamp of transmission of the signal; and
an interference level during transmission of the signal;
determine, based on the interference parameter, a configuration parameter indicative of a change in resource allocation of the cell and/or a change in coverage enhancing device configuration for reducing the interference level of an upcoming signal; and
provide instructions for the at least one network node to apply the configuration parameter to the upcoming signal transmissions of the at least one coverage enhancing device.

13. The system of claim 12, wherein the interference monitoring node comprises an interference monitoring server in the core network and/or a cloud server.

14. The system of claim 12, wherein the interference monitoring node comprises the at least one network node.

15. The system of claim 12, wherein the interference level is indicative of one or more of: network node-to-network node interference, network node-to-user equipment interference, user equipment-to-network node interference, and user equipment-to-user equipment interference.

16. The system of claim 12, wherein the interference level is indicative of one or more of cross-link interference, remote interference, inter-cell interference, and intracell interference.

17. The system of claim 12, wherein:
to obtain the interference parameter comprises to obtain, from a plurality of network nodes, interference parameters of a plurality of coverage enhancing devices located in one or more cells of the plurality of network nodes, and
to determine the configuration parameter is based on the interference parameters from the plurality of network nodes.

18. The system of claim 12, wherein to determine the configuration parameter comprises to apply, based on the interference parameter, a statistical model and/or a machine learning model to the interference parameter.

19. The system of claim 12, wherein to determine the configuration parameter comprises:
to determine, based on the interference parameter, a risk parameter indicative of potential interference risk of the upcoming signal;
wherein the configuration parameter is based on the risk parameter.

20. The system of claim 12, wherein to apply the configuration parameter comprises to provide an updated resource allocation to the at least one network node.
